(19) United States
(12) Patent Application Publication
(10) Pub. No.: US 2013/0209739 A1
(43) Pub. Date: Aug. 15, 2013

(54) MODELING MATERIAL, METHOD, AND APPARATUS FOR MANU-FACTURING A THREE-DIMENSIONAL OBJECT BY MELT LAYERING

(71) Applicant: FIT-FRUTH INNOVATIVE TECHNOLOGIEN GMBH, (US)

(72) Inventor: CARL FRUTH, PARSBERG (DE)

(73) Assignee: FIT-FRUTH INNOVATIVE TECHNOLOGIEN GMBH, PARSBERG (DE)

(21) Appl. No.: 13/762,893

(22) Filed: Feb. 8, 2013

(30) Foreign Application Priority Data
Feb. 9, 2012 (DE) 10 2012 002 419.3

(51) Int. Cl. B05D 3/00

(52) U.S. Cl. CPC B05D 3/00
USPC 428/156; 427/256; 118/202

(57) ABSTRACT

A method and an apparatus for manufacturing a three-dimensional object by melt layering, wherein the object is built up in layers from a meltable modeling material. The modeling material is provided in rod form in order to provide precise, but nevertheless simple, material delivery for the melt layering process.

### CROSS-REFERENCE TO RELATED APPLICATION

This application claims the priority, under 35 U.S.C. §119, of German patent application DE 10 2012 002 419.3, filed Feb. 9, 2012; the prior application is herewith incorporated by reference in its entirety.

### BACKGROUND OF THE INVENTION

### Field of the Invention

The present invention relates to a method and an apparatus for manufacturing a three-dimensional object by melt layering. In the process, the object is built up in layers from a meltable modeling material. The invention further relates to such modeling material.

A production method from the rapid prototyping sector that is referred to as “fused deposition modeling” (FDM) or “melt layering” is known from the prior art. A three-dimensional object is thereby built up in layers using a meltable plastic. Corresponding apparatuses are also referred to as “3-D printers.”

In the method, a modeling material is liquefied by melting, and is deposited in layers onto a build platform with the aid of a nozzle that is freely displaceable in a production plane in the X-Y direction. The build platform is lowered in the Z direction in accordance with the applied layer thickness. After the modeling material is extruded, it cools and solidifies, and the individual layers join to yield the desired three-dimensional object.

The modeling material used in the process is either an already-liquid modeling material or a solid modeling material that must additionally be liquefied. When liquid modeling material is used, correspondingly sealed containers must be utilized. They must be closed and opened, respectively, upon a change in material; this is comparatively complex. It is therefore preferred to use solid modeling material. This is usually a plastic material or wax material. In the case of the methods known from the prior art, the solid modeling material is made available in the form of a wire-shaped filament strand. The flexible modeling filament is present in roll form. It is wound onto a spool, and delivered from there to the FDM apparatus.

This conventional method is associated with a variety of disadvantages. For example, the modeling filament, usually manufactured using an extrusion method, can have a fluctuating diameter, which results in a material volume that changes in the wire direction and thus in a fluctuating material flow rate at the nozzle. Undesired fluctuations in layer thickness occur as a result. The slippage occurring upon feeding of the filament strand, which likewise causes irregularities in material application, has furthermore proven disadvantageous. Likewise disadvantageous is the laborious handling of the filament spools, especially when a material change is necessary during the building of an object.

### SUMMARY OF THE INVENTION

It is accordingly an object of the invention to provide a method, an apparatus, and a material which overcome the above-mentioned disadvantages of the heretofore-known devices and methods of this general type and which provides for a particularly precise, but nevertheless simple, material delivery for a melt layering method.

With the foregoing and other objects in view there is provided, in accordance with the invention, a meltable modeling material for manufacturing a three-dimensional object by melt layering, wherein the object is built up in layers from the modeling material, the material comprising: a modeling-material rod being a rod-shaped bar of the meltable modeling material.

There is also provided, in accordance with the invention, a method for manufacturing a three-dimensional object. The method comprises:

providing a modeling material in form of a rod-shaped bar of meltable modeling material; and

building up the object in layers by melt-layering the meltable modeling material.

There is also provided, in accordance with the invention, an apparatus for manufacturing a three-dimensional object by melt layering, the apparatus comprising: a device for feeding a modeling-material rod in the form of a rod-shaped bar of meltable modeling material for building up the object in layers from the meltable modeling material.

Advantageous embodiments of the invention are described in the dependent claims. The advantages and embodiments explained below in connection with the method also apply analogously to the apparatus according to the present invention for carrying out the method and to the modeling material according to the present invention, and vice versa.

A central concept of the invention is to use, instead of a flexible, wire-shaped filament strand wound onto a spool and in principle of any length, a solid modeling material that is present in rod or bar form and has a defined finite length. In other words, before liquefaction the modeling material is embodied as a rod or bar. Because of its rod or bar shape, a modeling-material rod of this kind, hereinafter referred to simply as a “modeling rod” or “rod,” is substantially rigid and is therefore much easier to handle than the existing roll material. Handling of the modeling material is thereby considerably simplified. In particular, it is possible to change the modeling material very much more simply and rapidly. In addition, the modeling rod, corresponding to the natural shape of a rod, is by preference substantially straight, and for that reason as well is particularly easy to handle, store, and transport.

Because the modeling rod can be manufactured by injection molding, a very much more precise geometry of the modeling material to be delivered to the extrusion head of the 3-D printer is possible, with reasonable outlay. In particular, the volume in the longitudinal direction of the rod can be kept extremely constant.

The modeling rod can have a circular cross section. It is particularly advantageous, however, if the modeling rod has a non-round cross section, since in that case precise profiling of the modeling rod is particularly easy. In an embodiment of the invention, the modeling rod has for this purpose a surface profile that changes in the longitudinal direction of the rod. In a particularly advantageous embodiment of the invention, a surface profile of this kind ensures secure and uniform feeding of the modeling material into the extrusion head, and thus precise metering of the desired quantity of material. This surface profile extends at least in portions, but preferably continuously, over the entire length of the modeling rod.

The surface profile can be made up, for example, of elevations distributed irregularly over the rod surface, yielding an uneven, rough surface that, because of the elevated friction, results in improved feeding of the modeling material when conventional, more or less smooth feed rollers are used to transport the modeling rod. The changing surface profile is, however, preferably constituted by well-defined profile elements, arranged spaced apart from one another in the longitudinal direction of the rod, that are arranged at preferably uniform spacings on the surface of the modeling rod.

The profile elements are preferably teeth projecting from the surface of the modeling rod, thus yielding a toothed modeling rod. The teeth preferably extend perpendicularly to the longitudinal direction of the rod, which advantageously corresponds at the same time to the feed direction of the modeling material. In specific circumstances, however, an oblique position of the teeth in the feed direction or opposite to the feed direction is also possible. A toothed modeling rod of this kind makes possible positively engaged driving of the modeling rod, resulting in particularly uniform feeding with no slippage. Driving occurs, for example, with the aid of a number of drive wheels or drive rollers that possess correspondingly profiled drive elements, in particular with the aid of one or more gears.

If the modeling rod comprises a single flat lateral surface, the profile elements are then preferably arranged on that lateral surface. Comparatively secure delivery of the modeling rod to the extrusion nozzle is already possible with this single-side arrangement of profile elements. Preferably, however, profile elements are provided on two mutually oppositely located lateral surfaces of the modeling rod, such as those that are present in the case of a modeling rod having a rectangular cross section.

The profile elements are preferably arranged in such a way that the cross-sectional area of the modeling rod is always constant. In an embodiment of the invention, for this purpose the profile elements are arranged offset from one another in the longitudinal direction of the rod. A constant cross-sectional area guarantees that the quantity of modeling material delivered to the extrusion head remains constant despite the changing surface profile, so that a consistent flow of material is ensured.

In a further embodiment of the invention, the profiling of the modeling rod moreover serves for determination and monitoring of the position of the modeling material delivered to the extrusion head, and thus for flow rate monitoring and/or for monitoring the feed drive system, in particular for slippage checking.

It is likewise possible to use modeling rods that do not have any profiling. In this case the conventional drive system suitable for spooled goods can in some circumstances be reused.

The utilization according to the present invention of modeling rods instead of spooled goods makes it possible to accurately define the length of the modeling rods to be used before they are utilized. The modeling rods can thus be prefabricated in object-specific fashion, i.e. in a manner adapted to the particular object to be manufactured. For example, if the use of four modeling rods is stipulated for manufacturing a specific object, the sequence of rods can be transposed or rods can be exchanged, i.e. replaced with other rods. This yields a plurality of object variants that can be implemented in very simple fashion. The use of modeling rods instead of spooled goods makes possible particularly simple individualization of objects, especially in terms of the material used and/or the colors used.

A further embodiment, in which the modeling rod that is used is constructed in multi-component fashion, has proven particularly advantageous especially with regard to the capability, opened up by the invention, of combining different modeling materials with one another in particularly simple fashion and thus producing individual objects, one of the results thereof being that corresponding customer desires can be reacted to quickly. In other words, the rod is not homogeneous in terms of the rod material. Instead of a uniform rod material, at least two different materials, i.e. materials having different material properties, are utilized. This can be implemented particularly simply using the multi-component injection molding technology that is known in principle to one skilled in the art; both coaxial multi-component injection molding and multi-component composite injection molding can be used. The different melts used in this context can involve different materials, for example a hard and a soft material, and/or different colors. The number of melts used, and the combination or arrangement thereof in the context of manufacture of the modeling rod, are advantageously determined in accordance with the object that is to be manufactured using the modeling rod. In the case of objects that are to be built up using different materials, for example, a corresponding material sequence can be provided a priori in the modeling rod, making available exactly the necessary quantity of material.

In a further embodiment of the invention, one or more reactive substances are used as components of a multi-component modeling rod; these are understood in general as substances that react upon melting. This involves as a rule a chemical reaction with another reactive-substance component provided specifically for that purpose, or with a material component of the modeling material provided in any case, while they melt together.

A reaction of this kind can bring about, for example, colors that change during the manufacturing process, e.g. during curing, or at a later point in time, or else the reaction can result in an illumination of the object along the lines of a “glow” effect, thereby producing an object or object part that is temporarily or permanently self-luminous. The reaction brought about can also consist in the deployment of a fragrance, which occurs briefly, e.g. during manufacture of the object, or a scent that adheres permanently to the object is made available.

In a further embodiment of the invention, the modeling rod contains one more cavities, preferably in the form of channels extending in the longitudinal direction of the rod, these cavities being filled with one or more reactive substances. When these reactive substances contact one another, for example during the melting operation, a chemical reaction then occurs as described above.

If the cross section of the modeling rod is not constant but rather variable, a multi-component rod can also be embodied in such a way that a core or a rod base having a constant diameter can have placed around it further components that differ from the core material in terms of material and/or color. Variable-cross-section modeling rods of this kind can be manufactured comparatively easily using conventional injection molding techniques. The application of differently-colored material allows modeling rods having a relief-like surface to be made available; the relief can assume any desired shape, for example letters or figures. An object-specific variation in layer thickness can be enabled in simple fashion with the aid of modeling rods having cross sections that change. For the processing of such modeling rods, the extrusion head of the 3-D printer comprises a correspondingly adapted extrusion nozzle that preferably adapts variably to the cross section of the modeling rod.

When multiple modeling rods are used to manufacture an object, they can then, in a simple embodiment of the invention, be delivered manually, the modeling rods being connected to one another by hand at their ends. Automatic rod feeding, however, is particularly advantageous; in this, the modeling rods are automatically delivered to the extrusion head and/or automatically connected to one another in order to ensure uninterrupted material delivery. For this purpose the modeling rods have at their ends connecting elements that are embodied for creating a mechanical connection to a further modeling rod, and in particular are suitable for automatic mutual engagement or connection. Connecting elements for constituting a catch connection or snap connection have proven particularly advantageous in this context. Alternatively thereto or in order to assist the creation of the connection of the rod ends, it is possible to use connecting elements in the form of small magnets that are recessed into the rod ends and utilize a magnetic attraction force to assist or bring about the connection of the rod ends.

Other features which are considered as characteristic for the invention are set forth in the appended claims.

Although the invention is illustrated and described herein as embodied in a modeling material, a method, and an apparatus for manufacturing a three-dimensional object by melt layering, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic elevation view of a prior art 3-D printer;

FIG. 2 is a similar view of a 3-D printer according to the present invention;

FIGS. 3A and 3B are elevation views of a modeling rod according to the invention, shown from 90°-offset viewing directions; and

FIG. 4 is a diagrammatic view of a delivery device.

### DETAILED DESCRIPTION OF THE INVENTION

Referring now to the figures of the drawing in detail, it will be noted that the figures show the invention merely schematically and with its primarily important constituents. Identical reference characters correspond to elements of identical or comparable function.

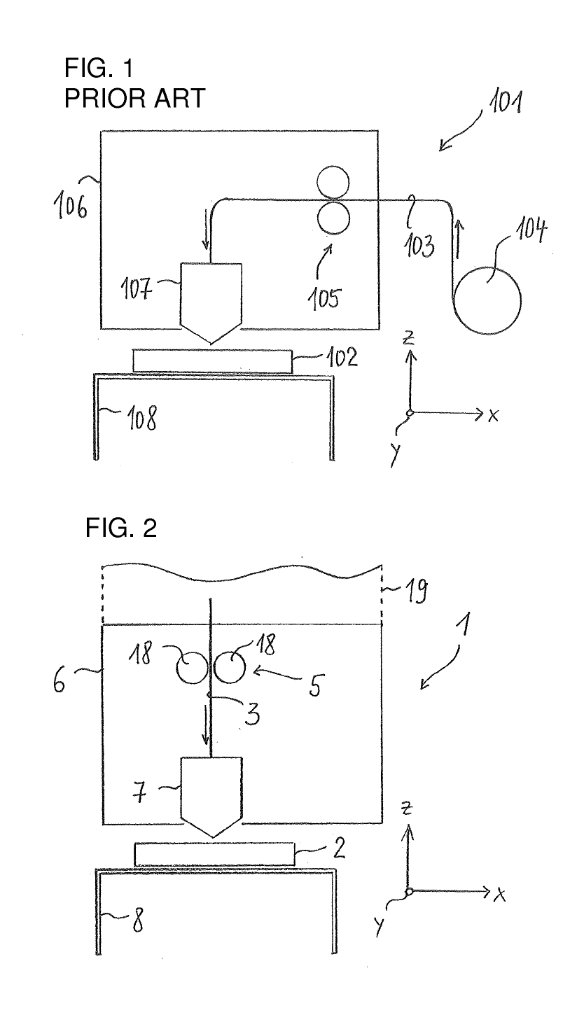

An apparatus 101 known from the existing art for manufacturing a three-dimensional object 102 by melt layering is depicted in FIG. 1. An object 102 is built up in layers from a meltable modeling material that is present in roll form as a filament 103 and is wound onto a spool 104. Two rollers engaging on a filament 103 serve as a drive system 105 for delivering the filament 103 into an extrusion head 106.

An apparatus 1 according to the present invention is illustrated in FIG. 2. There, modeling rods 3, as described below in further detail, are used to supply the modeling material.

The modeling material 3 is liquefied by heating and is deposited in layers, with the aid of a heatable extrusion nozzle 7 freely displaceable in a production plane in the X-Y direction, onto a build platform 8. Build platform 8 is lowered in the Z direction in accordance with the applied layer thickness. The liquefaction and extrusion of modeling material 3 takes place in an extrusion head 6 that possesses either a separate liquefier for melting modeling material 3 and an output nozzle for extruding the modeling material, or else, as in the example depicted, a heating nozzle 7 that is embodied both for liquefaction and for extrusion.

After the modeling material 3 is extruded, it cools and solidifies. The individual layers join to form the desired three-dimensional object 2.

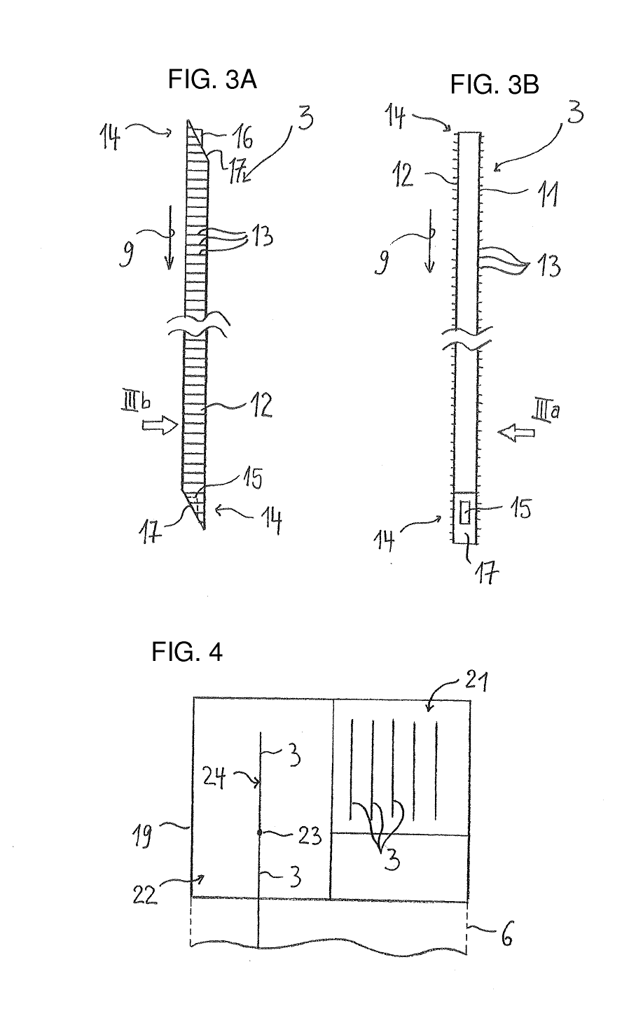

A modeling material rod 3 is depicted in FIG. 3. It is of elongated, straight configuration, and has a substantially square cross section. It can also be referred to as a rod-shaped bar 3. The length is, for example 30 cm, with a cross-sectional area of, for example, 3×3 mm. The modeling rod 3 is solid and substantially rigid, but nevertheless sufficiently flexible so that it does not break with ordinary handling. It is built up as a single component from a meltable plastic material, manufactured with the aid of an injection molding method, and has a surface profile that changes in longitudinal direction 9 of the rod. That profile is constituted by connecting elements in the form of teeth 13 projecting substantially perpendicularly out of lateral surfaces 11, 12 and arranged on two oppositely located lateral surfaces 11, 12 of rod 3. The first row of teeth arranged on the one lateral surface 11 is arranged with an offset from the second row of teeth arranged on the other, oppositely located lateral surface 12, in such a way that the material volume of rod 3, viewed in longitudinal direction 9 of the rod, does not change. Rod 3 comprises connecting elements 15, 16 at its ends 14. These elements are embodied here by way of example as tongue-and-groove elements. Groove 15 and tongue 16 project from complementary connecting surfaces 17 which result from the fact that ends 14 of modeling rod 3 are beveled. With rods 3 in the interlinked state, connecting surfaces 17 of adjacent rods abut against one another.

To ensure a continuous delivery of material, the necessary modeling rods 3 are delivered successively to extrusion head 6. For this, 3-D printer 1 comprises an electric-motor drive system 5 that effects feeding of the modeling material. The drive system 5 encompasses two gear wheels 18 located opposite one another. The teeth of these gears 18 are embodied in such a way that they serve as feed elements that engage on the modeling rod 3 and interact positively (i.e., with a form lock) with profile elements 13 of modeling rod 3.

Also possible are 3-D printers 1 having multiple extrusion heads 6 operating in parallel or sequentially, in which two or more modeling rods 3 are made available simultaneously. Advantageously, one of modeling rods 3 serves in this context to make available support material for building up support structures that can easily be removed again once object 2 has cured.

A specific number of predefined modeling rods 3 is necessary for the manufacture of a specific object 2. The length of modeling rods 3 depends on object 2 that is to be manufactured, and their sequence of use is likewise predefined. The same is true of the rod cross section, if rods 3 having a variable cross section are utilized. The basis for the production of modeling rods 3 is a data model of object 2 that exists, for example, in the STL format.

The necessary modeling rods 3 are delivered preferably automatically to extrusion head 6 once they have been automatically connected to one another. For this, 3-D printer 1 comprises a material delivery device 19, fixedly connected or selectably connectable to extrusion head 6, as depicted in FIG. 4. Delivery device 19 encompasses a supply container 21 for receiving a number of modeling rods 3, preferably in a defined or definable sequence. Coupled to supply container 21 is a connector 22 that receives rods 3 from supply container 21 and connects them to one another at their ends 14. Rods 3 are delivered to connector 22 preferably automatically, for example by the action of gravity, or with the assistance of a motorized drive system. Connector 22 connects rods 3 to one another by creating a connection between the connecting element provided at end 14 of the one modeling rod 3 and the connecting element provided at end 14 of the next modeling rod 3. If the connecting elements are, for example, snap elements, connector 22 creates the snap connection by snap-locking the snap elements. The connection is symbolized in FIG. 4 by a dot 23. Connector 22 thus generates interlinked rods in the form of a rod assemblage 24 that is delivered, with the aid of means known to one skilled in the art, for example a further drive system, to extrusion head 6 and ensures a continuous flow of material there. In a further embodiment of the invention, modeling rod packets, in which rods 3 required for the manufacture of a specific object 2 are already contained in the correct arrangement, are provided for filling supply container 21.

It is likewise possible to provide the profiling described in connection with modeling rods 3 according to the present invention in the context of conventional modeling filament 103 that is present in roll form. More-precise material delivery is achieved in this case as well. If modeling filament 103 has a circular cross section, profiling can be achieved in particularly simple fashion (in the same way as with modeling rods 3 having a circular cross section) by introducing notches as profile elements into the filament bodies, which notches, together with corresponding teeth of the filament drive system, ensure positive drive and thus particularly uniform material delivery.

All features presented in the description, the claims that follow, and the drawings can be essential to the invention both individually and in any combination with one another. For example, it is also possible to use modeling rods 3 having no profiling, which are interlinked with one another with the aid of connecting elements 15, 16.

1. A meltable modeling material for manufacturing a three-dimensional object by melt layering, wherein the object is built up in layers from the modeling material, the material comprising:
a modeling-material rod being a rod-shaped bar of the meltable modeling material.

2. The modeling material according to claim 1, wherein said modeling-material rod has a non-round cross section.

3. The modeling material according to claim 1, wherein said modeling-material rod has a surface profile changing in a longitudinal direction of said rod-shaped bar.

4. The modeling material according to claim 3, wherein said surface profile is constituted by profile elements disposed apart from one another.

5. The modeling material according to claim 1, wherein said modeling-material rod has a specific length depending on the three-dimensional object to be manufactured.

6. The modeling material according to claim 1, wherein said modeling-material rod is built up as a multi-component bar.

7. The modeling material according to claim 1, wherein said modeling-material rod has at least one rod end formed with a connecting element for connection to a further modeling-material rod.

8. A method for manufacturing a three-dimensional object, the method which comprising:
providing a modeling material in form of a rod-shaped bar of meltable modeling material; and
building up the object in layers by melt-layering the meltable modeling material.

9. The method according to claim 8, wherein the providing step comprises providing multiple modeling-material rods and manufacturing the object from the multiple multiple-material rods.

10. The method according to claim 8, wherein the providing step comprises providing multiple modeling-material rods and manufacturing the object from the multiple multiple-material rods.

11. The method according to claim 10, which comprises automatically connecting the multiple modeling-material rods to one another.

12. An apparatus for manufacturing a three-dimensional object by melt layering, the apparatus comprising:
a device for feeding a modeling-material rod in the form of a rod-shaped bar of meltable modeling material for building up the object in layers from the meltable modeling material.

13. The apparatus according to claim 12, wherein said feeding device is a motorized drive system for feeding the modeling material into an extrusion head, said drive system comprising a plurality of feed elements engaging on said modeling-material rod, said feed elements being profiled to interact positively with profile elements of said modeling-material rod.

14. The apparatus according to claim 13, wherein said feeding device comprises a material delivery device for automatic delivery of a plurality of modeling-material rods into the extrusion head and/or for connecting respective modeling-material rods into a modeling-material rod assembly.
